(19) United States
(12) Patent Application Publication
(10) Pub. No.: US 2019/0217647 A1
(43) Pub. Date: Jul. 18, 2019

(54) TRANSFER PAPER

(71) Applicant: MITSUBISHI PAPER MILLS LIMITED, Tokyo (JP)

(72) Inventors: Masanori NAGOSHI, Tokyo (JP); Atsushi NAKAMURA, Tokyo (JP); Jun URASAKI, Tokyo (JP); Hideki TAKADA, Tokyo (JP)

(73) Assignee: MITSUBISHI PAPER MILLS LIMITED, Tokyo (JP)

(21) Appl. No.: 16/306,462

(22) PCT Filed: Jun. 6, 2017
(86) PCT No.: PCT/JP2017/020898

§ 371 Date: Nov. 30, 2018

(30) Foreign Application Priority Data
Jun. 14, 2016 (JP) 2016-118043
Jun. 14, 2016 (JP) 2016-118044
Jun. 14, 2016 (JP) 2016-118045

(51) Int. Cl. B41M 5/10

(52) U.S. Cl. CPC B41M 5/10

(57) ABSTRACT

The present invention relates to a transfer paper, which is:
(i) a transfer paper without a coating layer, which comprises a pulp, a filler and an urea phosphate esterified starch, or
(ii) a transfer paper having a coating layer, which comprises a base paper and one or more coating layer(s) provided on at least one side of the base paper, wherein an outermost coating layer positioned on the outermost side with respect to the base paper contains at least kaolin, calcium carbonate and a binder, wherein,
(α) the base paper contains an urea phosphate esterified starch, or
(β) the outermost coating layer contains an urea phosphate esterified starch.

According to the present invention, it is possible to provide a transfer paper excellent in image deterioration resistance, color development property, adhesion property and strike-through suppression property.

### TECHNICAL FIELD

The present invention relates to a transfer paper used for transferring an pattern in a sublimation transfer printing method for forming a pattern on a printing substrate such as a fiber material.

### BACKGROUND ART

As a method for forming a pattern on a printing substrate such as a textile material, a sublimation transfer printing method is known in which an pattern is printed on a transfer paper using sublimation textile ink to prepare a printed transfer paper, and the printed transfer paper is brought into close contact with the printing substrate to transfer the sublimation textile ink onto the printing substrate (see, for example, Patent Document 1 and Patent Document 2).

For a transfer paper used in the sublimation transfer printing method, a sublimation transfer sheet comprising a sheet type base material, and an ink accepting layer provided on one side or both sides of the sheet type base material, wherein the ink accepting layer contains a pigment, a binder, and a cationic resin, and as the binder, any one of starch, starch derivative, polyvinyl alcohol and modified polyvinyl alcohol, or a mixture of two or more thereof is used, is known as a sublimation transfer sheet excellent in absorptivity of aqueous ink and capable of obtaining a clear recorded image free from bleeding, and also excellent in ink transfer efficiency to a transferring object upon sublimation transfer (see, for example, Patent Document 3).

In addition, a sublimation inkjet textile transfer paper having a sublimation textile ink receiving layer on a substrate, wherein the sublimation textile ink receiving layer contains an water-soluble resin and fine particles, and contains synthetic amorphous silica as the fine particles, and having a peak of the minimum value in the relative value of the ultrasonic transmission intensity on the sublimation inkjet receiving layer side of the sublimation inkjet textile transfer paper within a measurement time of 3 seconds is known as a sublimation inkjet textile transfer paper having excellent ink absorption and drying properties in inkjet printing using sublimation textile ink and having good workability, as well as having good characteristics in terms of image reproducibility on the transfer sheet surface, heat resistance during heat transfer, image reproducibility on the surface of the transferred object after transfer and transfer efficiency (see, for example, Patent Document 4).

As a method of printing a pattern on a transfer paper using an ink containing a sublimation dye or a sublimation textile ink to prepare a printed transfer paper, an inkjet printing method is often used as described in Patent Document 3 and Patent Document 4.

### PRIOR ART DOCUMENTS

### Patent Documents

Patent Document 1: Japanese Patent Application Kokai Publication No. 2015-168705 (unexamined, published Japanese patent application)

Patent Document 2: Japanese Patent Application Kokai Publication No. 2015-124324 (unexamined, published Japanese patent application)

Patent Document 3: Japanese Patent Application Kokai Publication No. 2010-158875 (unexamined, published Japanese patent application)

Patent Document 4: Japanese Patent Application Kokai Publication No. 2010-058335 (unexamined, published Japanese patent application)

### SUMMARY OF THE INVENTION

### Problems to be Solved by the Invention

It is necessary to have two contradictory characteristics between a transfer paper which is a blank paper before a pattern is printed and a printed transfer paper which is obtained by printing a pattern on the transfer paper. That is, the transfer paper is required to have an ability to successfully receive a sublimation textile ink, while the printed transfer paper is required to have an ability to successfully transfer the sublimation textile ink to a printing substrate.

It is necessary for a transfer paper to improve its receptivity to a sublimation textile ink in order to become a printed transfer paper having a sharp image so as not to deteriorate the image quality of a pattern formed on a printing substrate. Furthermore, it is necessary for a transfer paper not to deteriorate the image quality of a pattern formed on a printing substrate from the printed transfer paper having a sharp image.

On the other hand, if the receptivity of the transfer paper to the sublimation textile ink is improved, there is a case that transfer of the sublimation textile ink becomes insufficient at the time of transferring for forming a pattern on the printing substrate by the printed transfer paper. As a result, reduction in color development property occurs in the printing substrate.

In order to carry out transfer by bringing a printed transfer paper and a printing substrate into close contact with each other, the printed transfer paper must be able to adhere well to the printing substrate. In the case of continuously transferring to a printing substrate, a printed transfer paper in the form of roll paper is brought into close contact with the printing substrate to carry out transfer. In particular, in order to continuously carry out transfer, it is more important that the printed transfer paper adheres well to the printing substrate.

Also, in order to successfully transfer a sublimation textile ink from a printed transfer paper to a printing substrate, a transfer paper must receive the sublimation textile ink without penetrating to the deep portion of the paper. That is, a transfer paper is required to have “strike through suppression property”. “Strike through” is a phenomenon in which a sublimation textile ink of an image printed on a transfer paper penetrates deep into the paper.

The quality of the sublimation transfer sheet of Patent Document 3 or the sublimation inkjet textile transfer paper of Patent Document 4 is not necessarily sufficient and it is desired to improve adhesion or strike-through suppression.

The sublimation transfer sheet of Patent Document 3 and the sublimation textile inkjet textile transfer paper of Patent Document 4 are coated paper types having an ink accepting layer or an ink receiving layer. Apart from the coated paper type, from the viewpoint of product cost in the market, an uncoated paper type without an ink accepting layer or an ink receiving layer is also required.

In view of the above, an object of the present invention is to provide a transfer paper satisfying the following items.

(1) Deterioration of an image in a printing substrate can be suppressed (image deterioration resistance).

(2) Reduction of color development in a printing substrate can be suppressed (color development property)

(3) A printed transfer paper and a printing substrate are well adhered (adhesion property)

(4) Strike-through can be suppressed in a printed transfer paper (strike-through suppression property)

### Means for Solving the Problems

As a result of extensive studies to solve the above problems, the present inventors have accomplished the object of the present invention by the following.

[1] A transfer paper, which is:

(i) a transfer paper without a coating layer, which comprises a pulp, a filler and an urea phosphate esterified starch, or

(ii) a transfer paper having a coating layer, which comprises a base paper and one or more coating layer(s) provided on at least one side of the base paper, wherein an outermost coating layer positioned on the outermost side with respect to the base paper contains at least kaolin, calcium carbonate and a binder, wherein,

(α) the base paper contains an urea phosphate esterified starch, or

(β) the outermost coating layer contains an urea phosphate esterified starch.

[2] The transfer paper according to [1], which is (i) a transfer paper without a coating layer, which comprises a pulp, a filler and an urea phosphate esterified starch.

[3] The transfer paper according to [2], wherein a content of the urea phosphate esterified starch in the transfer paper is 0.5 g/m² or more and 4 g/m² or less.

[4] The transfer paper according to [2] or [3], wherein at least one of the filler is calcium carbonate.

[5] The transfer paper according to [2], [3], or [4], further comprising a polycondensate of an aliphatic monoamine or an aliphatic polyamine and an epihalohydrin compound.

By these, it is possible to obtain a transfer paper with good image deterioration resistance and color development property, excellent in adhesion property, and excellent in strike-through suppression property. According to [4], it is possible to obtain a transfer paper with improved color development property and adhesion property. According to [5], it is possible to obtain a transfer paper with improved image deterioration resistance and strike-through suppression property.

[6] The transfer paper according to [1], which is (ii) a transfer paper having a coating layer, which comprises a base paper and one or more coating layer(s) provided on at least one side of the base paper, wherein an outermost coating layer positioned on the outermost side with respect to the base paper contains at least kaolin, calcium carbonate and a binder, wherein,

(α) the base paper contains an urea phosphate esterified starch.

[7] The transfer paper according to [6], wherein a content of the urea phosphate esterified starch in the base paper is 0.5 g/m² or more and 4 g/m² or less.

[8] The transfer paper according to [6] or [7], wherein the base paper further contains a water-soluble calcium salt.

By these, it is possible to obtain a transfer paper with good image deterioration resistance and color development property and excellent in adhesion property. According to [8], it is possible to obtain a transfer paper with improved color development property and adhesion property.

[9] The transfer paper according to [1], which is (ii) a transfer paper having a coating layer, which comprises a base paper and one or more coating layer(s) provided on at least one side of the base paper, wherein an outermost coating layer positioned on the outermost side with respect to the base paper contains at least kaolin, calcium carbonate and a binder, wherein, (β) the outermost coating layer contains an urea phosphate esterified starch.

[10] The transfer paper according to [9], wherein a content of the urea phosphate esterified starch in the outermost coating layer is 2 parts by mass or more and 48 parts by mass or less with respect to 100 parts by mass of a pigment in the outermost coating layer.

[11] The transfer paper according to [9] or [10], wherein the outermost coating layer further contains a water-soluble calcium salt.

[12] The transfer paper according to [8] or [11], wherein the water-soluble calcium salt is at least one selected from the group consisting of calcium chloride and calcium nitrate.

By these, it is possible to obtain a transfer paper with good image deterioration resistance and color development property and excellent in strike-through suppression property. According to [11], it is possible to obtain a transfer paper with improved image deterioration resistance and strike-through suppression property. According to [12], it is possible to obtain a transfer paper with improved image deterioration resistance.

[13] The transfer paper according to any one of [1] to [12], which is a transfer paper for printing a textile material.

[14] A method for transfer printing of a textile material, which comprises using the transfer paper according to any one of [1] to [12].

### MODE FOR CARRYING OUT THE INVENTION

The present invention will be described below in detail.

In the present invention, the term “transfer paper” means a paper in a blank state before a pattern to be transferred is printed. The term “printed transfer paper” means a paper on which a pattern to be transferred to a printing substrate has been printed.

The transfer paper of the present invention is characterized by containing an urea phosphate esterified starch.

A transfer paper can be roughly divided into (i) a non-coated paper type and (ii) a coated paper type. The transfer paper of the present invention may be of any of these types.

In the present invention, the “non-coated paper type” refers to a paper without distinct clear coating layer when observing a cross section of a transfer paper with an electron microscope. Further, in the present invention, for example, when a resin component or a polymer component has been applied and the said applied component has been absorbed by a paper, and then the cross section of the transfer paper is observed with an electron microscope to have confirmed that it does not have a distinct clear coating layer, such a paper is included in the non-coated paper type. A “coated paper type” refers to a paper having a distinct clear coating layer when observing the cross section of the transfer paper with an electron microscope.

(Non-Coated Paper Type Transfer Paper)

First, a non-coated paper type transfer paper without a coating layer will be described.

The non-coated paper type transfer paper of the present invention contains a pulp, a filler and an urea phosphate esterified starch. The non-coated paper type transfer paper of the present invention can be obtained by the following method (A) or (B). The method (B) is preferable since the adhesion is good with a small content of an urea phosphate esterified starch.

(A) A method of making a paper stock containing a pulp, a filler and an urea phosphate esterified starch into a paper.

(B) A method of making a paper stock containing a pulp and a filler into a paper, and providing an urea phosphate esterified starch to the resulting paper by a conventionally known coating apparatus such as a size press.

The paper stock used in the method (A) or (B) may optionally contain, in addition to the urea phosphate esterified starch, various additives which are conventionally known in the field of papermaking such as a binder, a sizing agent, a fixing agent, a retention aid, a cationizing agent, a pigment dispersant, a thickener, a flowability control agent, a defoamer, an antifoamer, a releasing agent, a foaming agent, a penetrating agent, a colored dye, a colored pigment, an optical brightener, an ultraviolet light absorber, an antioxidant, a preservative, a fungicide, an insolubilizer, and a paper strengthening agent.

Paper making is carried out by adjusting a paper stock to acidic, neutral or alkaline and using a conventionally known papermaking machine. Examples of papermaking machine include a fourdrinier papermaking machine, a twin wire papermaking machine, a combination papermaking machine, a cylindrical papermaking machine, a yankee papermaking machine and the like.

In the method (A), calendering and size press processing may be performed after paper making.

In the method (B), the paper obtained by paper making may be subjected to a calendering processing before or after providing an urea phosphate esterified starch. The coating composition for providing an urea phosphate esterified starch to the paper may contain a sizing agent or the like.

The basis weight of the non-coated paper type transfer paper is not particularly limited. From the viewpoint of ease of handling for transfer to a printing substrate, the basis weight of the non-coated paper type transfer paper is preferably 10 g/m² or more and 100 g/m² or less, more preferably 40 g/m² or more and 90 g/m² or less. The thickness of the transfer paper is not particularly limited. The thickness of the transfer paper is preferably 0.01 mm or more and 0.5 mm or less, and more preferably 0.05 mm or more and 0.3 mm or less from the viewpoint of ease of handling for transfer to a printing substrate.

Pulps are conventionally known in the papermaking field and examples of a pulp may include chemical pulps such as LBKP (Leaf Bleached Kraft Pulp) and NBKP (Needle Bleached Kraft Pulp), mechanical pulp such as GP (Groundwood Pulp), PGW (Pressure Ground Wood pulp), RMP (Refiner Mechanical Pulp), TMP (Thermo Mechanical Pulp), CTMP (ChemiThermo Mechanical Pulp), CMP (Chemi Mechanical Pulp) and CGP (Chemi Groundwood Pulp), and waste paper pulp such as DIP (Delnked Pulp). The pulp also includes non-wood pulp such as kenaf and bagasse.

The filler is a conventionally known white pigment in the field of papermaking. Examples of the filler may include white inorganic pigments such as calcium carbonate, kaolin clay, talc, calcium sulfate, barium sulfate, titanium dioxide, zinc oxide, zinc sulfide, zinc carbonate, satin white, aluminum silicate, diatomaceous earth, alumina, lithopone, zeolite, magnesium carbonate, and magnesium hydroxide. Further examples of the filler may include white organic pigments such as styrene type plastic pigment, acrylic type plastic pigment, polyethylene, microcapsule, urea resin, and melamine resin. From these fillers, one kind or two or more kinds of fillers can be selected to use.

The filler is preferably calcium carbonate. Calcium carbonate preferably occupies 60% by mass or more in the filler. The reason for this is that due to the synergistic effect with the urea phosphate esterified starch described later, color development property and adhesion property become more excellent.

Urea phosphate esterified starch is one type of esterified starch and is a starch derivative obtained by heating starch and urea at a high temperature in the presence of phosphoric acid to introduce a phosphate group and a carbamate group. Urea phosphate esterified starch also includes those having an alkylene group between a phosphate group and a glucose six-membered ring or between a carbamate group and a glucose six-membered ring. The alkylene group preferably has 1 to 3 carbon atoms, more preferably 1 carbon atom. Urea phosphate esterified starch is commercially available from Oji Cornstarch Co., Ltd., NIHON SHOKUHIN KAKO CO., LTD., General Starch Japan Co., Ltd., and the like.

The content of the filler in the non-coated paper type transfer paper is preferably 5 parts by mass or more and 40 parts by mass or less, more preferably 10 parts by mass or more and 30 parts by mass or less, still more preferably 15 parts by mass or more and 25 parts by mass or less.

The content of urea phosphate esterified starch in the non-coated paper type transfer paper is preferably 0.5 g/m² or more and 4 g/m² or less. In particular, in the case of the above method (A), it is preferably 0.5 g/m² or more and 4 g/m² or less, more preferably 0.6 g/m² or more and 3.8 g/m² or less. In the case of the above method (B), it is preferably 0.25 g/m² or more and 2 g/m² or less, more preferably 1.0 g/m² or more and 1.5 g/m² or less per side.

The non-coated paper type transfer paper preferably contains a polycondensate of an aliphatic monoamine or an aliphatic polyamine and an epihalohydrin compound. The reason for this is that image deterioration resistance and strike-through suppression property become better.

A method of including a polycondensate of an aliphatic monoamine or an aliphatic polyamine and an epihalohydrin compound in a paper is as follows:

(a) a method of blending a polycondensate of an aliphatic monoamine or an aliphatic polyamine and an epihalohydrin compound in a paper stock to make the paper stock into a paper;
(b) a method of making a paper stock containing a pulp, a filler and an urea phosphate esterified starch into a paper, and providing to the resulting paper a polycondensate of an aliphatic monoamine or an aliphatic polyamine and an epihalohydrin compound by a conventionally known coating apparatus such as a size press; or
(c) a method of making a paper stock containing a pulp and a filler into a paper, and providing to the resulting paper an urea phosphate esterified starch and a polycondensate of aliphatic monoamine or aliphatic polyamine and epihalohydrin compound by a conventionally known coating apparatus such as a size press. As a method of including a polycondensate of an aliphatic monoamine or an aliphatic polyamine and an epihalohydrin compound in a paper, the method (b) or (c) is preferred from the viewpoint of color development properties.

Examples of conventionally known coating apparatuses in the above methods (B), (b) and (c) may include a size press, a gate roll coater, a film transfer coater, a blade coater, a rod coater, an air knife coater, a curtain coater and the like. From the viewpoint of production cost, the coating apparatus is preferably a size press, a gate roll coater or a film transfer coater installed in a papermaking machine.

The polycondensate of an aliphatic monoamine or an aliphatic polyamine and an epihalohydrin compound is one type of cationic resins and is a polycondensate of at least one selected from aliphatic monoamines and aliphatic polyamines and at least one selected from epihalohydrin compounds. Aliphatic monoamines are, for example, monomethylamine, monoethylamine, dimethylamine, diethylamine, trimethylamine, triethylamine, mono-, di- or tri-ethanolamine, and the like.

Aliphatic polyamines are, for example, ethylenediamine, diethylenetriamine, triethylenetetramine, pentaethylenehexamine, hexamethylenediamine, dimethylaminoethylamine, dimethylaminopropylamine, 1,3-diaminobutane and the like. Epihalohydrin compounds are, for example, epichlorohydrin, epibromohydrin, methyl epichlorohydrin, methyl epibromohydrin and the like. The polycondensate of an aliphatic monoamine or an aliphatic polyamine and an epihalohydrin compound is preferably a dimethylamine-epichlorohydrin polycondensate since it is commercially available easily.

The content of a polycondensate of an aliphatic monoamine or an aliphatic polyamine and an epihalohydrin compound is preferably 0.5 g/m² or more and 3 g/m² or less. In particular, it is preferably 0.5 g/m² or more and 3 g/m² or less in the above method (a), and it is preferably 0.25 g/m² or more and 1.5 g/m² or less per side in the above methods (b) and (c).

(Coated Paper Type Transfer Paper)

Next, a coated paper type transfer paper having a coating layer will be described.

The coated paper type transfer paper of the present invention has a base paper and one or more coating layer(s) provided on at least one side of the base paper. In the case where the coating layer is one layer, the coating layer corresponds to the outermost coating layer. In the case of two or more coating layers, the coating layer positioned on the outermost side with respect to the base paper corresponds to the outermost coating layer. In the case of two or more coating layers, the coating layer existing between the base paper and the outermost coating layer is either a coating layer containing a pigment and a binder or a coating layer without containing a pigment, and it is not particularly limited.

From the viewpoint of production cost, the coating layer is preferably one layer. The coating layer may be provided on one side or both sides of the base paper. When the outermost coating layer according to the present invention is provided on one side of the base paper, the transfer paper may have a conventionally known back coat layer on the back face of the base paper.

The base paper is a papermaking paper obtained by making a paper stock containing at least one pulp selected from chemical pulp such as LBKP (Leaf Bleached Kraft Pulp) and NBKP (Needle Bleached Kraft Pulp), mechanical pulp such as GP (Groundwood Pulp), PGW (Pressure Ground Wood pulp), RMP (Refiner Mechanical Pulp), TMP (Thermo Mechanical Pulp), CTMP (ChemiThermoMechanical Pulp), CMP (Chemi Mechanical Pulp) and CGP (Chemi Groundwood Pulp), and waste paper pulp such as DIP (DeInked Pulp), various fillers such as calcium carbonate, talc, clay and kaolin, and various additives such as a sizing agent, a fixing agent, a retention aid, a cationizing agent and a paper strengthening agent as required into a paper. Further, the base paper includes fine paper which is subjected to calendering processing, surface size processing with starch, polyvinyl alcohol or the like, or surface processing or the like on a papermaking paper. Further, the base paper includes fine paper which has been subjected to calendering processing after subjected to surface size processing or surface processing.

Paper making is carried out by adjusting a paper stock to acidic, neutral or alkaline and using a conventionally known papermaking machine. Examples of a papermaking machine include a fourdrinier papermaking machine, a twin wire papermaking machine, a combination papermaking machine, a cylindrical papermaking machine, a yankee papermaking machine and the like.

The basis weight of the base paper is not particularly limited. From the viewpoint of ease of handling for transfer to a printing substrate, the basis weight of the base paper is preferably 10 g/m² or more and 100 g/m² or less, more preferably 40 g/m² or more and 90 g/m² or less. Further, the thickness of the transfer paper is not particularly limited. The thickness of the transfer paper is preferably 0.01 mm or more and 0.5 mm or less, and more preferably 0.05 mm or more and 0.3 mm or less from the viewpoint of ease of handling for transfer to a printing substrate.

In the paper stock, one or two or more of other additives selected from a pigment dispersant, a thickener, a flowability control agent, a defoamer, an antifoamer, a releasing agent, a foaming agent, a penetrating agent, a colored dye, a colored pigment, an optical brightener, an ultraviolet light absorber, an antioxidant, a preservative, a fungicide, an insolubilizer, an wet paper strengthening agent, a dry paper strengthening agent can be blended appropriately as long as the desired effect of the present invention is not impaired.

In the coated paper type transfer paper, the coating layer or the outermost coating layer can be provided by applying and drying each coating layer-coating composition on the base paper or the coating layer. The method of providing is not particularly limited. For example, an applying method and a drying method using a coating apparatus and a drying apparatus conventionally known in the field of papermaking can be mentioned. Examples of conventionally known coating apparatuses may include a size press, a gate roll coater, a film transfer coater, a blade coater, a rod coater, an air knife coater, a comma coater, a gravure coater, a bar coater, an E bar coater, a curtain coater, and the like. Examples of drying apparatuses may include various drying apparatuses including a hot air dryer such as a straight tunnel dryer, an arch dryer, an air loop dryer and a sine curve air float dryer, an infrared heating dryer, a dryer using microwave, and the like.

The applying amount of the coating layer is not particularly limited. From the viewpoint of the production cost of a transfer paper and easy adhesion to a printing substrate, the applying amount is preferably 2 g/m² or more and 70 g/m² or less in terms of dry solid content per one side. The upper limit of the applying amount is more preferably 30 g/m² or less, still more preferably 10 g/m² or less. Furthermore, the applying amount is most preferably 2 g/m² or more and 8 g/m² or less per side, because the production cost can be reduced and it is possible to prevent the coating layer of the transfer paper from being missing when adhering to a printing substrate. When there are a plurality of coating layers per one side, the applying amount is the total value thereof.

In the coated paper type transfer paper, the outermost coating layer contains a pigment and a binder.

In the coated paper type transfer paper, (α) the base paper contains an urea phosphate esterified starch, or (β) the outermost coating layer contains an urea phosphate esterified starch.

Here, the urea phosphate esterified starch is one type of esterified starch, and is a starch derivative obtained by heating starch and urea at a high temperature in the presence of a phosphoric acid to introduce a phosphate group and a carbamate group, like the urea phosphate esterified starch used in the case of non-coated paper type transfer paper. Urea phosphate esterified starch also includes those having an alkylene group between a phosphate group and a glucose six-membered ring or between a carbamiate group and a glucose six-membered ring. The alkylene group preferably has 1 to 3 carbon atoms, more preferably 1 carbon atom. Urea phosphate esterified starch is commercially available from Oji Cornstarch Co., Ltd., NIHON SHOKUHIN KAKO CO., LTD., General Starch Japan Co., Ltd., and the like. The urea phosphate esterified starch also functions as a binder.

When (α) the base paper contains urea phosphate esterified starch, a method of including urea phosphate esterified starch in the base paper may include the following:

(L) a method of making a paper stock containing a pulp, a filler, an urea phosphate esterified starch and, if necessary, additives into a paper; or
(M) a method of making a paper stock containing a pulp, a filler and, if necessary, additives into a paper, and providing to the resulting paper an urea phosphate esterified starch by a conventionally known coating apparatus such as a size press. Such a method is preferably the method (M) because adhesion is good with a small content.

In the above method (L), calendering processing and size press processing may be carried out after paper making.

In the above method (M), the paper obtained by papermaking may be subjected to calendering processing before or after providing urea phosphate esterified starch. The coating composition for providing urea phosphate esterified starch may contain a sizing agent or the like.

Here, when the outermost coating layer contains urea phosphate esterified starch, it does not exclude that the base paper contains urea phosphate esterified starch.

The content of urea phosphate esterified starch in the base paper is preferably 0.5 g/m² or more and 4 g/m² or less. In particular, in the case of the above method (L), it is preferably 0.5 g/m² or more and 4 g/m² or less, more preferably 0.6 g/m² or more and 3.8 g/m² or less. In the case of the above method (M), it is preferably 0.25 g/m² or more and 2 g/m² or less per one side.

In the coated paper type transfer paper, when the base paper contains urea phosphate esterified starch, the base paper preferably contains a water-soluble calcium salt. The reason for this is that the color development property and adhesion property become better.

The water-soluble calcium salt is a calcium salt which can finally be dissolved by 1% by mass or more in water at 20° C. Examples of the water-soluble calcium salt may include a salt compound such as calcium lactate, calcium nitrate, calcium chloride, calcium formate and calcium acetate, or a complex salt such as calcium ethylenediaminetetraacetate. One or two or more water-soluble calcium salts are selected from the group consisting of these. Among them, the water-soluble calcium salt is preferably one or two selected from the group consisting of calcium chloride and calcium nitrate.

A method of including a water-soluble calcium salt in a base paper may include the following:

(l) a method of incorporating a water-soluble calcium salt into a paper stock and making the paper stock into a paper,
(m) a method of making a paper stock containing a pulp, a filler, urea phosphate esterified starch and, if necessary, additives into a paper, and providing to the resulting paper a water-soluble calcium salt by a conventionally known coating apparatus such as a size press,
(n) a method of making a paper stock containing a pulp, a filler and, if necessary, additives into a paper, and providing to the resulting paper urea phosphate esterified starch and a water-soluble calcium salt by a conventionally known coating apparatus such as a size press. From the viewpoint of color development property, the method of including a water-soluble calcium salt is preferably (m) or (n).

The content of the water-soluble calcium salt in the base paper is preferably 1 g/m² or more and 10 g/m² or less. Particularly, in the case of the above method (1), it is preferably 1 g/m² or more and 10 g/m² or less, and in the case of the above method (m) or (n), it is preferably 0.5 g/m² or more and 5 g/m² or less per one side.

Examples of conventionally known coating apparatuses in the above method (M), (m) and (n) may include a size press, a gate roll coater, a film transfer coater, a blade coater, a rod coater, an air knife coater, a comma coater, a gravure coater, a bar coater, an E bar coater, a curtain coater, and the like. From the viewpoint of production cost, the coating apparatus is preferably a size press, a gate roll coater or a film transfer coater installed in a papermaking machine.

(β) When the outermost coating layer contains urea phosphate esterified starch, as a method of including urea phosphate esterified starch in the outermost coating layer, a method of incorporating urea phosphate esterified starch in the outermost coating layer-coating composition, and then applying and drying the coating composition.

When the outermost coating layer contains a binder in addition to the urea phosphate esterified starch, the proportion occupied by the urea phosphate esterified starch in the binder of the outermost coating layer is preferably 40% by mass or more and 80% by mass or less, more preferably 60% by mass or more and 70% by mass or less.

The outermost coating layer may contain a conventionally known binder other than urea phosphate esterified starch. Examples of conventionally known binders other than urea phosphate esterified starch may include starch, various modified starches other than urea phosphate esterified starch, cellulose derivatives such as carboxymethyl cellulose and hydroxyethyl cellulose, natural polymer resin such as casein, gelatin, soybean protein, pullulan, gum arabic, karaya gum and albumin or a derivative thereof, polyvinyl pyrrolidone, polyvinyl alcohol and various modified polyvinyl alcohols, polyacrylamide, polyethylene imine, polypropylene glycol, polyethylene glycol, maleic anhydride resin, acrylic resin, methacrylate-butadiene copolymer, a styrene-butadiene copolymer, an ethylene-vinyl acetate copolymer, or a functional group-modified copolymers of these various copolymers with monomers containing a functional group such as carboxy group, a binder such as a thermosetting synthetic resin such as a melamine resin and an urea resin, polyurethane resins, unsaturated polyester resins, polyvinyl butyral, alkyd resins latex, and the like. The outermost coating layer can contain one kind or a combination of two or more kinds of these binders in combination with urea phosphate esterified starch.

When the base paper contains urea phosphate esterified starch, from the viewpoint of image deterioration resistance, it is preferable that at least one of the binders of the outermost coating layer is starch, or various modified starch except for urea phosphate esterified starch. Here, it does not exclude that the outermost coating layer contains urea phosphate esterified starch.

When the outermost coating layer contains urea phosphate esterified starch, conventionally known binders used in combination with urea phosphate esterified starch are preferably polyvinyl alcohol and various modified polyvinyl alcohols thereof from the viewpoint of image deterioration resistance.

The content of the binder in the outermost coating layer is preferably 5 parts by mass or more, more preferably 20 parts by mass or more, based on 100 parts by mass of the pigment in the outermost coating layer. The content of the binder in the outermost coating layer is preferably 60 parts by mass or less, more preferably 40 parts by mass or less, based on 100 parts by mass of the pigment in the outermost coating layer.

In the coated paper type transfer paper of the present invention, the content of urea phosphate esterified starch in the outermost coating layer is preferably 2 parts by mass or more, more preferably 3 parts by mass or more, and still more preferably 5 parts by mass or more, based on 100 parts by mass of the pigment(s) in the outermost coating layer. The content of urea phosphate esterified starch in the outermost coating layer is preferably 48 parts by mass or less, more preferably 36 parts by mass or less, still more preferably 24 parts by mass or less, based on 100 parts by mass of the pigment(s) in the outermost coating layer. Here, the mass of the pigment(s) in the outermost coating layer is the sum of masses including kaolin, calcium carbonate and other pigments contained in the outermost coating layer, if present.

In the coated paper type transfer paper, the outermost coating layer contains kaolin and calcium carbonate as pigments.

When the base paper contains urea phosphate esterified starch, the mass ratio of kaolin and calcium carbonate contained in the outermost coating layer is preferably that kaolin:calcium carbonate=9:1 to 6:4, more preferably that kaolin:calcium carbonate=8:2 to 7:3.

When the outermost coating layer contains urea phosphate esterified starch, the mass ratio of kaolin and calcium carbonate contained in the outermost coating layer is preferably that kaolin:calcium carbonate=8:2 to 5:5, more preferably that kaolin:calcium carbonate=7:3 to 6:4.

For reasons of printability for inkjet printing systems, calcium carbonate is preferably ground calcium carbonate.

In addition to kaolin and calcium carbonate, the outermost coating layer may contain conventionally known pigments. Examples of conventionally known pigments may include inorganic pigments such as talc, satin white, lithopone, titanium oxide, zinc oxide, silica, alumina, aluminum hydroxide, zinc oxide, activated clay, diatomaceous earth, and organic pigments such as plastic pigments. The outermost coating layer can contain one or two or more of these pigments in combination, in combination with kaolin and calcium carbonate.

The proportion of kaolin and calcium carbonate in the pigments of the outermost coating layer is preferably 70% by mass or more, more preferably 80% by mass or more.

When the outermost coating layer contains urea phosphate esterified starch, it is preferable that the outermost coating layer contains a water-soluble calcium salt. The reason for this is that image deterioration resistance and strike-through suppression property become better.

Here, the water-soluble calcium salt is the same as the water-soluble calcium salt used in the case of the coated paper type transfer paper in which base paper contains urea phosphate esterified starch, and the description thereof is omitted. Examples of the water-soluble calcium salt may include a salt compound such as calcium lactate, calcium nitrate, calcium chloride, calcium formate and calcium acetate, or a complex salt such as calcium ethylenediaminetetraacetate. One or two or more water-soluble calcium salts are selected from the group consisting of these. Among them, the water-soluble calcium salt is preferably one or two selected from the group consisting of calcium chloride and calcium nitrate.

As a method of including a water-soluble calcium salt in the outermost coating layer, there can be mentioned a method of incorporating a water-soluble calcium salt in the coating composition for the outermost coating layer, followed by applying and drying the coating composition.

The content of the water-soluble calcium salt in the outermost coating layer is preferably 2 parts by mass or more and 30 parts by mass or less based on 100 parts by mass of the pigment(s) in the outermost coating layer. The lower limit of the content is more preferably 5 parts by mass or more, still more preferably 10 parts by mass or more. The upper limit of the content is more preferably 25 parts by mass or less, and still more preferably 20 parts by mass or less.

The outermost coating layer may contain various additives conventionally known in the field of coated paper, if necessary. Examples of the additives may include a dispersant, a fixing agent, a thickener, a flowability control agent, a defoamer, a releasing agent, a foaming agent, a penetrating agent, a colored pigment, a colored dye, an optical brightener, an antioxidant, a preservative, fungicide and the like.

Further, the outermost coating layer can contain various auxiliaries conventionally known in a sublimation transfer printing method. The auxiliaries are added to optimize various physical properties of the outermost coating layer-coating composition or to improve the dyeability of the transferred sublimation textile ink. Examples of the auxiliaries may include various surfactants, humectants, wetting agents, pH adjusting agents, alkaline agents, color-deepning agents, deaerators, reducing inhibitors and the like.

A printed transfer paper can be obtained by printing a pattern on a transfer paper using various conventionally known printing methods using sublimation textile ink.

Various printing methods for printing a pattern on a transfer paper are conventionally known printing methods, and are not particularly limited. Examples of the printing method may include a gravure printing method, an inkjet printing method, an electrophotographic printing method, a screen printing method, and the like. Among them, an inkjet printing method is preferable from the viewpoints of high definition of image quality and downsizing of the apparatus.

The sublimation transfer printing method using sublimation textile ink is a method having a step of printing a pattern on a transfer paper to obtain a printed transfer paper and a step of bringing the printed transfer paper into close contact with a printing substrate. The step of bringing into close contact includes heating and pressurizing as necessary. Conditions of heating and pressurizing in the step of bringing into close contact are conventionally known conditions in a sublimation transfer printing method. As the step of bringing into close contact, for example, there can be mentioned a method of bringing a printed transfer paper into close contact with a printing substrate by a pressing machine, a heating drum or the like, and heating and pressurizing.

The printing substrate is a fiber material, and is not particularly limited. The fiber material may be either a natural fiber material or a synthetic fiber material. Examples of the natural fiber material may include cellulosic fiber materials such as cotton, hemp, lyocell, rayon and acetate, and protein fiber materials such as silk, wool and animal hair. Examples of the synthetic fiber material may include polyamide fiber (nylon), vinylon, polyester, polyacrylic and the like. As a configuration of the fiber material, there can be mentioned single, blended, mixed fiber or interwoven fabric such as woven fabric, knitted fabric and nonwoven fabric. Furthermore, these configurations may be combined. If necessary, the printing substrate may be pretreated with a drug or the like effective for promoting dyeing.

### EXAMPLES

Hereinafter, the present invention will be described in more detail by examples. It should be noted that the present invention is not limited to these examples. Here, “part by mass” and “% by mass” each represent “parts by mass” and “% by mass” of a dry solid content or a substantial component amount. An applying amount of a coating layer represents a dry solid content.

Regarding the obtained transfer paper, preparation of a printed transfer paper, printing on a printing substrate, evaluation of strike-through suppression property, image deterioration resistance, color development property and adhesion property were carried out in the following manner.

<Preparation of Printed Transfer Paper>

Evaluation patterns with sublimation dye inks (cyan, magenta, yellow, black) were printed on each transfer paper described below using an inkjet printer (JV 2-130 II, manufactured by Mimaki Engineering Co., Ltd.) using sublimation dye ink to obtain each printed transfer paper.

<Evaluation of Strike-Through Suppression Property>

From the viewpoint of the image visibility from the back side of the printed transfer paper and the image quality of the obtained transferred printing substrate, the obtained printed transfer paper was visually evaluated for strike-through suppression property according to the following criteria. In the present invention, if the evaluation is A or B, the transfer paper is judged to have excellent strike-through suppression property.

A: There is almost no strike-through, and the texitile printed image is good.

B: Strike-through is slightly observed, but it is generally good.

C: Strike-through is observed, but it is not a practical problem.

D: Strike-through is recognized, which causes problems in practical use.

<Textile Printing (Cut Paper)>

A polyester cloth was used as a printing substrate. The resultant printed transfer paper and the polyester cloth were brought into close contact with each other and heated at 200° C. for 1 minute using a thermal transfer press (manual wide swinger Model 221, manufactured by Insta Graphic Systems) to transfer the dye to the polyester cloth, and then the printed transfer paper was peeled off from the polyester cloth to obtain a polyester cloth having a pattern formed thereon.

<Evaluation of Image Deterioration Resistance>

From the viewpoint of the sharpness of the pattern, the image deterioration resistance of the polyester cloth having the pattern formed thereon was visually evaluated according to the following criteria. In the present invention, if the evaluation is A or B, the transfer paper is judged to have good image deterioration resistance.

A: Good level.

B: Deterioration of image quality is hardly recognized and it is generally good level.

C: Deterioration of image quality is recognized, but there is no practical problem level.

D: Level at which deterioration of image which becomes practically impossible is recognized.

<Evaluation of Color Development Property>

In the textile printed printing substrate, the color density of the solid image portion of three sublimation dye inks (cyan, magenta, yellow) in the evaluation pattern was measured with an optical densitometer (X-rite 530, manufactured by SAKATA INX ENG. CO., LTD.), and color density values of three colors were added up. Color development property was judged according to the following criteria. In the present invention, it is judged that the color development property of the transfer paper is good if the evaluation is A or B.

A: Total value is 4.7 or more

B: Total value is 4.4 or more and less than 4.7

C: Total value is less than 4.4

<Textile Printing (Roll Paper)>

Polyester cloth of scroll was used as a printing substrate. The resultant roll paper-like printed transfer paper and the polyester cloth were brought into close contact with each other, and the dye was transferred to the polyester cloth using a heating and pressing machine (190° C., 0.5 MPa, 2.5 m/min, roller type). Thereafter, the printed transfer paper was peeled off from the polyester cloth to obtain a polyester cloth having a pattern formed thereon.

<Evaluation of Adhesion Property>

From the viewpoint of the degree of occurrence of transfer unevenness and distortion of the pattern, the polyester cloth having the pattern formed thereon was visually evaluated on adhesion property according to the following criteria.

A: Transfer unevenness and distortion are not recognized, and it is good level.

B: Transfer unevenness and distortion are scarcely observed, and it is generally good level.

C: Transfer unevenness and distortion are observed, but there is no problem in practical use.

D: Transfer unevenness and distortion are recognized, and this is a problematic level in practical use.

The non-coated paper type transfer paper according to the present invention will be described with reference to Examples.

<Preparation of Non-Coated Paper Type Transfer Paper>

### Example 1-1

20 parts by mass of calcium carbonate as a filler, 0.8 parts by mass of urea phosphate esterified starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side and 1.0 g/m² of dimethylamine-epichlorohydrin polycondensate per one side were adhered on both sides of the paper with a size press machine. Then, machine calendering processing was carried out to prepare a non-coated paper type transfer paper having a basis weight of 85 g/m².

### Example 1-2

20 parts by mass of calcium carbonate as a filler, 6 parts by mass of urea phosphate esterified starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side and 1.0 g/m² of dimethylamine-epichlorohydrin polycondensate per one side were adhered on both sides of the paper with a size press machine. Then, machine calendering processing was carried out to prepare a non-coated paper type transfer paper having a basis weight of 85 g/m².

### Example 1-3

20 parts by mass of calcium carbonate as a filler, 0.8 part by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 0.25 g/m² of urea phosphate esterified starch per one side and 1.0 g/m² of dimethylamine-epichlorohydrin polycondensate per one side were adhered on both sides of the paper with a size press machine. Then, machine calendering processing was carried out to prepare a non-coated paper type transfer paper having a basis weight of 82.5 g/m².

### Example 1-4

20 parts by mass of calcium carbonate as a filler, 0.8 part by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.0 g/m² of urea phosphate esterified starch per one side and 1.0 g/m² of dimethylamine-epichlorohydrin polycondensate per one side were adhered on both sides of the paper with a size press machine. Then, machine calendering processing was carried out to prepare a non-coated paper type transfer paper having a basis weight of 84 g/m².

### Example 1-5

20 parts by mass of calcium carbonate as a filler, 0.8 part by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side and 1.0 g/m² of dimethylamine-epichlorohydrin polycondensate per one side were adhered on both sides of the paper with a size press machine. Then, machine calendering processing was carried out to prepare a non-coated paper type transfer paper having a basis weight of 85 g/m².

### Example 1-6

20 parts by mass of calcium carbonate as a filler, 0.8 part by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 2.0 g/m² of urea phosphate esterified starch per one side and 1.0 g/m² of dimethylamine-epichlorohydrin polycondensate per one side were adhered on both sides of the paper with a size press machine. Then, machine calendering processing was carried out to prepare a non-coated paper type transfer paper having a basis weight of 86 g/m².

### Example 1-7

20 parts by mass of kaolin clay as a filler, 0.8 part by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side and 1.0 g/m² of dimethylamine-epichlorohydrin polycondensate per one side were adhered on both sides of the paper with a size press machine. Then, machine calendering processing was carried out to prepare a non-coated paper type transfer paper having a basis weight of 85 g/m².

### Example 1-8

12 parts by mass of calcium carbonate and 8 parts of kaolin clay as fillers, 0.8 part by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side and 1.0 g/m² of dimethylamine-epichlorohydrin polycondensate per one side were adhered on both sides of the paper with a size press machine. Then, machine calendering processing was carried out to prepare a non-coated paper type transfer paper having a basis weight of 85 g/m².

### Example 1-9

20 parts by mass of calcium carbonate as a filler, 6 parts by mass of urea phosphate esterified starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side was adhered on both sides of the paper with a size press machine. Then, machine calendering processing was carried out to prepare a non-coated paper type transfer paper having a basis weight of 83 g/m².

### Example 1-10

20 parts by mass of calcium carbonate as a filler, 0.8 part by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side was adhered on both sides of the paper with a size press machine. Then, machine calendering processing was carried out to prepare a non-coated paper type transfer paper having a basis weight of 83 g/m².

### Example 1-11

20 parts by mass of calcium carbonate as a filler, 6 parts by mass of urea phosphate esterified starch, 0.8 part by mass of aluminum sulfate, 0.1 parts by mass of alkyl ketene dimer type sizing agent, and 1.6 g/m² of dimethylamine-epichlorohydrin polycondensate were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side was adhered on both sides of the paper with a size press machine. Then, machine calendering processing was carried out to prepare a non-coated paper type transfer paper having a basis weight of 83 g/m².

### Example 1-12

20 parts by mass of calcium carbonate as a filler, 0.8 part by mass of amphoteric starch, 0.8 part by mass of aluminum sulfate, 0.1 parts by mass of alkyl ketene dimer type sizing agent, and 1.6 g/m² of dimethylamine-epichlorohydrin polycondensate were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side was adhered on both sides of the paper with a size press machine. Then, machine calendering processing was carried out to prepare a non-coated paper type transfer paper having a basis weight of 83 g/m².

### Comparative Example 1-1

20 parts by mass of calcium carbonate as a filler, 0.8 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side was adhered on both sides of the paper with a size press machine. Then, machine calendering processing was carried out to prepare a non-coated paper type transfer paper having a basis weight of 83 g/m².

### Comparative Example 1-2

20 parts by mass of calcium carbonate as a filler, 0.8 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of phosphate esterified starch per one side was adhered on both sides of the paper with a size press machine. Then, machine calendering processing was carried out to prepare a non-coated paper type transfer paper having a basis weight of 83 g/m².

For the non-coated paper type transfer papers, strike-through suppression property, image deterioration resistance, color development property and adhesion property were evaluated. The evaluation results are shown in Table 1.

TABLE 1

| | Strike-through | Image | Color | |
|---|---|---|---|---|
| | suppression | deterioration | development | Adhesion |
| | property | resistance | property | property |
| Example 1-1 | A | A | A | B |
| Example 1-2 | A | A | A | A |
| Example 1-3 | A | A | A | A |
| Example 1-4 | A | A | A | A |
| Example 1-5 | A | A | A | A |
| Example 1-6 | A | A | A | A |
| Example 1-7 | A | A | B | B |
| Example 1-8 | A | A | A | A |
| Example 1-9 | B | B | B | A |
| Example 1-10 | B | B | B | A |
| Example 1-11 | A | A | B | A |
| Example 1-12 | A | A | B | A |
| Comparative | C | D | C | D |
| Example 1-1 | | | | |
| Comparative | C | C | C | D |
| Example 1-2 | | | | |

From the evaluation results in Table 1, it is understood that Examples 1-1 to 1-12 corresponding to the present invention have image deterioration resistance and color development property, and are excellent in adhesion and strike-through suppression properties. It is understood that Comparative Examples 1-1 and 1-2 which do not satisfy the constitution of the present invention cannot obtain the effect of the present invention.

Mainly from the comparison between Example 1-5, Example 1-7 and Example 1-8, it is understood that when 60% by mass or more of the filler is calcium carbonate, it is preferable in respect of color development property and adhesion property.

Mainly from the comparison between Example 1-2, Example 1-9 and Example 1-11, and the comparison between Example 1-5, Example 1-10 and Example 1-12, it is understood that when a non-coated paper type transfer paper contains a polycondensate of an aliphatic monoamine or an aliphatic polyamine and an epihalohydrin compound, it is preferable in respect of image deterioration resistance and strike-through suppression property.

Next, a coated paper type transfer paper in which a base paper contains urea phosphate esterified starch according to the present invention will be described by Examples.

### Example 2-1

<Base Paper 2-1>

30 parts by mass of calcium carbonate as a filler, 1.2 parts by mass of urea phosphate esterified starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side and 1.0 g/m² of calcium nitrate per one side were adhered on both sides of the paper with a size press machine. Then, machine calendering processing was carried out to prepare a base paper having a basis weight of 62 g/m².

<Outermost Coating Layer-Coating Composition 2-1>

The outermost coating layer-coating composition was prepared according to the following contents.

| | |
|---|---|
| Kaolin | 75 parts by mass |
| Ground calcium carbonate | 25 parts by mass |
| Styrene-butadiene copolymer | 10 parts by mass |
| Phosphate esterified starch | 10 parts by mass |

The above contents were blended, mixed and dispersed with water, and the concentration was adjusted to 48% by mass.

<Preparation of Coated Paper Type Transfer Paper>

A transfer paper was prepared by the following procedure.

On the base paper, the outermost coating layer-coating composition was applied on both sides with an air knife coater, and dried. After that, it was subjected to calendering processing to obtain a transfer paper of Example 2-1. The applied amount was 9 g/m² per one side.

### Example 2-2

A transfer paper of Example 2-2 was obtained in the same manner as in Example 2-1, except that the base paper 2-1 was changed to the base paper 2-2.

<Base Paper 2-2>

30 parts by mass of calcium carbonate as a filler, 9 parts by mass of urea phosphate esterified starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side and 1.0 g/m² of calcium nitrate per one side were adhered on both sides of the paper with a size press machine. Then, machine calendering processing was carried out to prepare a base paper having a basis weight of 62 g/m².

### Example 2-3

A transfer paper of Example 2-3 was obtained in the same manner as in Example 2-1, except that the base paper 2-1 was changed to the base paper 2-3.

<Base Paper 2-3>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 0.25 g/m² of urea phosphate esterified starch per one side and 1.0 g/m² of calcium nitrate per one side were adhered on both sides of the paper with a size press machine. Then, machine calendering processing was carried out to prepare a base paper having a basis weight of 59.5 g/m².

### Example 2-4

A transfer paper of Example 2-4 was obtained in the same manner as in Example 2-1, except that the base paper 2-1 was changed to the base paper 2-4.

<Base Paper 2-4>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.0 g/m² of urea phosphate esterified starch per one side and 1.0 g/m² of calcium nitrate per one side were adhered on both sides of the paper with a size press machine. Then, machine calendering processing was carried out to prepare a base paper having a basis weight of 61 g/m².

### Example 2-5

A transfer paper of Example 2-5 was obtained in the same manner as in Example 2-1, except that the base paper 2-1 was changed to the base paper 2-5.

<Base Paper 2-5>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side and 1.0 g/m² of calcium nitrate per one side were adhered on both sides of the paper with a size press machine. Then, machine calendering processing was carried out to prepare a base paper having a basis weight of 62 g/m².

### Example 2-6

A transfer paper of Example 2-6 was obtained in the same manner as in Example 2-1, except that the base paper 2-1 was changed to the base paper 2-6.

<Base Paper 2-6>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 2.0 g/m² of urea phosphate esterified starch per one side and 1.0 g/m² of calcium nitrate per one side were adhered on both sides of the paper with a size press machine. Then, machine calendering processing was carried out to prepare a base paper having a basis weight of 63 g/m².

### Example 2-7

A transfer paper of Example 2-7 was obtained in the same manner as in Example 2-1, except that the base paper 2-1 was changed to the base paper 2-7.

<Base Paper 2-7>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side and 1.0 g/m² of calcium chloride per one side were adhered on both sides of the paper with a size press machine. Then, machine calendering processing was carried out to prepare a base paper having a basis weight of 62 g/m².

### Example 2-8

A transfer paper of Example 2-8 was obtained in the same manner as in Example 2-1, except that the base paper 2-1 was changed to the base paper 2-8.

<Base Paper 2-8>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side and 1.0 g/m² of calcium acetate per one side were adhered on both sides of the paper with a size press machine. Then, machine calendering processing was carried out to prepare a base paper having a basis weight of 62 g/m².

### Example 2-9

A transfer paper of Example 2-9 was obtained in the same manner as in Example 2-1, except that the base paper 2-1 was changed to the base paper 2-9.

<Base Paper 2-9>

30 parts by mass of calcium carbonate as a filler, 9 parts by mass of urea phosphate esterified starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side was adhered on both sides of the paper with a size press machine. Then, machine calendering processing was carried out to prepare a base paper having a basis weight of 60 g/m².

### Example 2-10

A transfer paper of Example 2-10 was obtained in the same manner as in Example 2-1, except that the base paper 2-1 was changed to the base paper 2-10.

<Base Paper 2-10>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side was adhered on both sides of the paper with a size press machine. Then, machine calendering processing was carried out to prepare a base paper having a basis weight of 60 g/m².

### Example 2-11

A transfer paper of Example 2-11 was obtained in the same manner as in Example 2-1, except that the base paper 2-1 was changed to the base paper 2-11.

<Base Paper 2-11>

30 parts by mass of calcium carbonate as a filler, 9 parts by mass of urea phosphate esterified starch, 0.8 part by mass of aluminum sulfate, 0.1 parts by mass of alkyl ketene dimer type sizing agent, and 2.5 parts by mass of calcium nitrate were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side was adhered on both sides of the paper with a size press machine. Then, machine calendering processing was carried out to prepare a base paper having a basis weight of 60 g/m².

### Example 2-12

A transfer paper of Example 2-12 was obtained in the same manner as in Example 2-1, except that the base paper 2-1 was changed to the base paper 2-12.

<Base Paper 2-12>

30 parts by mass of calcium carbonate as a filler, 1.2 parts by mass of amphoteric starch, 0.8 part by mass of aluminum sulfate, 0.1 parts by mass of alkyl ketene dimer type sizing agent, and 2.5 parts by mass of calcium nitrate were added to a pulp slurry comprising 100 parts by mass of LBKP having a freeness degree of 380 ml csf to form a paper stock, and the paper stock was made into a paper by a fourdrinier papermaking machine, and 1.5 g/m² of urea phosphate esterified starch per one side was adhered on both sides of the paper with a size press machine. Then, machine calendering processing was carried out to prepare a base paper having a basis weight of 60 g/m².

### Example 2-13

A transfer paper of Example 2-13 was obtained in the same manner as in Example 2-5, except that the outermost coating layer-coating composition 2-1 was changed to the outermost coating layer-coating composition 2-2.

<Outermost Coating Layer-Coating Composition 2-2>

The outermost coating layer-coating composition was prepared according to the following contents.

| | |
|---|---|
| Kaolin | 90 parts by mass |
| Ground calcium carbonate | 10 parts by mass |
| Styrene-butadiene copolymer | 10 parts by mass |
| Phosphate esterified starch | 10 parts by mass |

The above contents were blended, mixed and dispersed with water, and the concentration of the composition was adjusted to 48% by mass.

### Example 2-14

A transfer paper of Example 2-14 was obtained in the same manner as in Example 2-5 except that the outermost coating layer-coating composition 2-1 was changed to the outermost coating layer-coating composition 2-3.

<Outermost Coating Layer-Coating Composition 2-3>

The outermost coating layer-coating composition was prepared according to the following contents.

| | |
|---|---|
| Kaolin | 60 parts by mass |
| Ground calcium carbonate | 40 parts by mass |
| Styrene-butadiene copolymer | 10 parts by mass |
| Phosphate esterified starch | 10 parts by mass |

The above contents were blended, mixed and dispersed with water, and the concentration of the composition was adjusted to 48% by mass.

### Example 2-15

A transfer paper of Example 2-15 was obtained in the same manner as in Example 2-5 except that the outermost coating layer-coating composition 2-1 was changed to the outermost coating layer-coating composition 2-4.

<Outermost Coating Layer-Coating Composition 2-4>

The outermost coating layer-coating composition was prepared according to the following contents.

| | |
|---|---|
| Kaolin | 60 parts by mass |
| Ground calcium carbonate | 20 parts by mass |
| Synthetic amorphous silica | 20 parts by mass |
| Styrene-butadiene copolymer | 10 parts by mass |
| Phosphate esterified starch | 10 parts by mass |

The above contents were blended, mixed and dispersed with water, and the concentration of the composition was adjusted to 48% by mass.

### Example 2-16

A transfer paper of Example 2-16 was obtained in the same manner as in Example 2-5 except that the outermost coating layer-coating composition 2-1 was changed to the outermost coating layer-coating composition 2-5.

<Outermost Coating Layer-Coating Composition 2-5>

The outermost coating layer-coating composition was prepared according to the following contents.

| | | |
|---|---|---|
| Kaolin | 52.5 | parts by mass |
| Ground calcium carbonate | 17.5 | parts by mass |
| Synthetic amorphous silica | 30 | parts by mass |
| Styrene-butadiene copolymer | 10 | parts by mass |
| Phosphate esterified starch | 10 | parts by mass |

The above contents were blended, mixed and dispersed with water, and the concentration of the composition was adjusted to 48% by mass.

### Example 2-17

Coating layer-coating composition 2-1 was applied to the base paper 2-5 on both sides with an air knife coater, dried, and then subjected to calendering processing to obtain a coated paper. The applied amount was 3 g/m² per one side. The outermost coating layer-coating composition 2-1 was applied to the coated paper on both sides with a blade coater, dried, and then subjected to calendering processing to obtain a transfer paper of Example 2-17. The applied amount was 9 g/m² per one side.

<Coating Layer-Coating Composition 2-1>

The coating layer-coating composition was prepared according to the following contents.

| | |
|---|---|
| Ground calcium carbonate | 100 parts by mass |
| Styrene-butadiene copolymer | 15 parts by mass |
| Polyvinyl alcohol | 10 parts by mass |

The above contents were blended, mixed and dispersed with water, and the concentration of the composition was adjusted to 38% by mass.

### Comparative Example 2-1

A transfer paper of Comparative Example 2-1 was obtained in the same manner as in Example 2-1, except that the base paper 2-1 was changed to the base paper 2-13.

<Base Paper 2-13>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side was adhered on both sides of the paper with a size press machine. Then, machine calendering processing was carried out to prepare a base paper having a basis weight of 60 g/m².

### Comparative Example 2-2

A transfer paper of Comparative Example 2-2 was obtained in the same manner as in Example 2-1, except that the base paper 2-1 was changed to the base paper 2-14.

<Base Paper 2-14>

30 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of phosphate esterified starch per one side was adhered on both sides of the paper with a size press machine. Then, machine calendering processing was carried out to prepare a base paper having a basis weight of 60 g/m².

### Comparative Example 2-3

A transfer paper of Comparative Example 2-3 was obtained in the same manner as in Example 2-5, except that the outermost coating layer-coating composition 2-1 was changed to the outermost coating layer-coating composition 2-6.

<Outermost Coating Layer-Coating Composition 2-6>

The outermost coating layer-coating composition was prepared according to the following contents.

| | |
|---|---|
| Kaolin | 100 parts by mass |
| Styrene-butadiene copolymer | 10 parts by mass |
| Phosphate esterified starch | 10 parts by mass |

The above contents were blended, mixed and dispersed with water, and the concentration of the composition was adjusted to 48% by mass.

### Comparative Example 2-4

A transfer paper of Comparative Example 2-4 was obtained in the same manner as in Example 2-5, except that the outermost coating layer-coating composition 2-1 was changed to the outermost coating layer-coating composition 2-7.

<Outermost Coating Layer-Coating Composition 2-7>

The outermost coating layer-coating composition was prepared according to the following contents.

| | |
|---|---|
| Ground calcium carbonate | 100 parts by mass |
| Styrene-butadiene copolymer | 10 parts by mass |
| Phosphate esterified starch | 10 parts by mass |

The above contents were blended, mixed and dispersed with water, and the concentration of the composition was adjusted to 48% by mass.

### Comparative Example 2-5

A transfer paper of Comparative Example 2-5 was obtained in the same manner as in Example 2-5, except that the outermost coating layer-coating composition 2-1 was changed to the outermost coating layer-coating composition 2-8.

<Outermost coating layer-coating composition 2-8>

The outermost coating layer-coating composition was prepared according to the following contents.

| | |
|---|---|
| Synthetic amorphous silica | 100 parts by mass |
| Styrene-butadiene copolymer | 10 parts by mass |
| Phosphate esterified starch | 10 parts by mass |

The above contents were blended, mixed and dispersed with water, and the concentration of the composition was adjusted to 48% by mass.

With respect to coated paper type transfer paper, image deterioration resistance, color development property and adhesion property were evaluated. The evaluation results are shown in Table 2.

TABLE 2

| | Image | Color | |
|---|---|---|---|
| | deterioration | development | Adhesion |
| | resistance | property | property |
| Example 2-1 | A | A | B |
| Example 2-2 | A | A | A |
| Example 2-3 | A | A | A |
| Example 2-4 | A | A | A |
| Example 2-5 | A | A | A |
| Example 2-6 | A | A | A |
| Example 2-7 | A | A | A |
| Example 2-8 | B | A | A |
| Example 2-9 | A | B | B |
| Example 2-10 | A | B | B |
| Example 2-11 | A | B | A |
| Example 2-12 | A | B | A |
| Example 2-13 | B | A | A |
| Example 2-14 | A | A | B |
| Example 2-15 | A | A | A |
| Example 2-16 | A | B | B |
| Example 2-17 | A | A | A |
| Comparative | D | C | D |
| Example 2-1 | | | |
| Comparative | C | C | D |
| Example 2-2 | | | |
| Comparative | D | A | A |
| Example 2-3 | | | |
| Comparative | C | C | D |
| Example 2-4 | | | |
| Comparative | B | C | D |
| Example 2-5 | | | |

From the evaluation results in Table 2, it is understood that Examples 2-1 to 2-17 corresponding to the present invention have image deterioration resistance and color development property and are excellent in adhesion property. However, it is understood that Comparative Examples 2-1 to 2-5 that do not satisfy the constitution of the present invention cannot obtain the effects of the present invention.

Mainly from the comparison of Example 2-2 and Example 2-11 with Example 2-9, as well as from the comparison of Example 2-5, Example 2-7, Example 2-8 and Example 2-12 with Example 2-10, it is found that the base paper preferably contains a water-soluble calcium salt.

Further, mainly from the comparison of Example 2-5 and Example 2-7 with Example 2-8, it is understood that the water-soluble calcium salt is preferably at least one selected from the group consisting of calcium chloride and calcium nitrate.

Next, a coated paper type transfer paper in which the outermost coating layer contains urea phosphate esterified starch according to the present invention will be described by examples.

### Example 3-1

<Base Paper 3-1>

20 parts by mass of calcium carbonate as a filler, 1.2 parts by mass of amphoteric starch, 0.8 part by mass of aluminum sulfate, and 0.1 parts by mass of alkyl ketene dimer type sizing agent were added to a pulp slurry comprising 100 parts by mass of LBKP having a freeness degree of 380 ml csf to form a paper stock, and the paper stock was made into a paper by a fourdrinier papermaking machine, and 1.5 g/m² of oxidized starch per one side was adhered on both sides of the paper with a size press machine. Then, machine calendering processing was carried out to prepare a base paper having a basis weight of 60 g/m².

<Outermost Coating Layer-Coating Composition 3-1>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 15 parts by mass |
| Polyvinyl alcohol | 10 parts by mass |

The above contents were blended, mixed and dispersed with water, and the concentration of the composition was adjusted to 48% by mass.

<Preparation of Coated Paper Type Transfer Paper>

A transfer paper was prepared by the following procedure.

On the base paper, the outermost coating layer-coating composition was applied on both sides with an air knife coater, dried, and then subjected to calendering processing to obtain a transfer paper of Example 3-1. The applied amount was 6 g/m² per side.

### Example 3-2

A transfer paper of Example 3-2 was obtained in the same manner as in Example 3-1, except that the outermost coating layer-coating composition 3-1 was changed to the outermost coating layer-coating composition 3-2.

<Outermost coating layer-coating composition 3-2>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 10 parts by mass |
| Polyvinyl alcohol | 15 parts by mass |
| Calcium nitrate | 10 parts by mass |

The above contents were blended, mixed and dispersed with water, and the concentration of the composition was adjusted to 48% by mass.

### Example 3-3

A transfer paper of Example 3-3 was obtained in the same manner as in Example 3-1, except that the outermost coating layer-coating composition 3-1 was changed to the outermost coating layer-coating composition 3-3.

<Outermost Coating Layer-Coating Composition 3-3>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 15 parts by mass |
| Polyvinyl alcohol | 10 parts by mass |
| Calcium nitrate | 10 parts by mass |

The above contents were blended, mixed and dispersed with water, and the concentration of the composition was adjusted to 48% by mass.

### Example 3-4

A transfer paper of Example 3-4 was obtained in the same manner as in Example 3-1, except that the outermost coating layer-coating composition 3-1 was changed to the outermost coating layer-coating composition 3-4.

<Outermost Coating Layer-Coating Composition 3-4>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 17.5 parts by mass |
| Polyvinyl alcohol | 7.5 parts by mass |
| Calcium nitrate | 10 parts by mass |

The above contents were blended, mixed and dispersed with water, and the concentration of the composition was adjusted to 48% by mass.

### Example 3-5

A transfer paper of Example 3-5 was obtained in the same manner as in Example 3-1, except that the outermost coating layer-coating composition 3-1 was changed to the outermost coating layer-coating composition 3-5.

<Outermost Coating Layer-Coating Composition 3-5>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 20 parts by mass |
| Polyvinyl alcohol | 5 parts by mass |
| Calcium nitrate | 10 parts by mass |

The above contents were blended, mixed and dispersed with water, and the concentration of the composition was adjusted to 48% by mass.

### Example 3-6

A transfer paper of Example 3-6 was obtained in the same manner as in Example 3-3, except that the outermost coating layer-coating composition 3-3 was changed to the outermost coating layer-coating composition 3-6.

<Outermost Coating Layer-Coating Composition 3-6>

The outermost coating layer-coating composition was prepared according to the following contents.

| | |
|---|---|
| Kaolin | 80 parts by mass |
| Ground calcium carbonate | 20 parts by mass |
| Urea phosphate esterified starch | 15 parts by mass |
| Polyvinyl alcohol | 10 parts by mass |
| Calcium nitrate | 10 parts by mass |

The above contents were blended, mixed and dispersed with water, and the concentration of the composition was adjusted to 48% by mass.

### Example 3-7

A transfer paper of Example 3-7 was obtained in the same manner as in Example 3-3, except that the outermost coating layer-coating composition 3-3 was changed to the outermost coating layer-coating composition 3-7.

<Outermost Coating Layer-Coating Composition 3-7>

The outermost coating layer-coating composition was prepared according to the following contents.

| | |
|---|---|
| Kaolin | 70 parts by mass |
| Ground calcium carbonate | 30 parts by mass |
| Urea phosphate esterified starch | 15 parts by mass |
| Polyvinyl alcohol | 10 parts by mass |
| Calcium nitrate | 10 parts by mass |

The above contents were blended, mixed and dispersed with water, and the concentration of the composition was adjusted to 48% by mass.

### Example 3-8

A transfer paper of Example 3-8 was obtained in the same manner as in Example 3-3, except that the outermost coating layer-coating composition 3-3 was changed to the outermost coating layer-coating composition 3-8.

<Outermost Coating Layer-Coating Composition 3-8>

The outermost coating layer-coating composition was prepared according to the following contents.

| | |
|---|---|
| Kaolin | 50 parts by mass |
| Ground calcium carbonate | 50 parts by mass |
| Urea phosphate esterified starch | 15 parts by mass |
| Polyvinyl alcohol | 10 parts by mass |
| Calcium nitrate | 10 parts by mass |

The above contents were blended, mixed and dispersed with water, and the concentration of the composition was adjusted to 48% by mass.

### Example 3-9

A transfer paper of Example 3-9 was obtained in the same manner as in Example 3-3, except that the outermost coating layer-coating composition 3-3 was changed to the outermost coating layer-coating composition 3-9.

<Outermost coating layer-coating composition 3-9>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 15 parts by mass |
| Polyvinyl alcohol | 10 parts by mass |
| Calcium chloride | 10 parts by mass |

The above contents were blended, mixed and dispersed with water, and the concentration of the composition was adjusted to 48% by mass.

### Example 3-10

A transfer paper of Example 3-10 was obtained in the same manner as in Example 3-3, except that the outermost coating layer-coating composition 3-3 was changed to the outermost coating layer-coating composition 3-10.

<Outermost Coating Layer-Coating Composition 3-10>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 15 parts by mass |
| Polyvinyl alcohol | 10 parts by mass |
| Calcium acetate | 10 parts by mass |

The above contents were blended, mixed and dispersed with water, and the concentration of the composition was adjusted to 48% by mass.

### Example 3-11

A transfer paper of Example 3-11 was obtained in the same manner as in Example 3-3, except that the outermost coating layer-coating composition 3-3 was changed to the outermost coating layer-coating composition 3-11.

<Outermost coating layer-coating composition 3-11>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 15 parts by mass |
| Polyvinyl alcohol | 10 parts by mass |
| Calcium nitrate | 2 parts by mass |

The above contents were blended, mixed and dispersed with water, and the concentration of the composition was adjusted to 48% by mass.

### Example 3-12

A transfer paper of Example 3-12 was obtained in the same manner as in Example 3-3, except that the outermost coating layer-coating composition 3-3 was changed to the outermost coating layer-coating composition 3-12.

<Outermost Coating Layer-Coating Composition 3-12>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 15 parts by mass |
| Polyvinyl alcohol | 10 parts by mass |
| Calcium nitrate | 30 parts by mass |

The above contents were blended, mixed and dispersed with water, and the concentration of the composition was adjusted to 48% by mass.

### Example 3-13

A transfer paper of Example 3-13 was obtained in the same manner as in Example 3-3, except that the outermost coating layer-coating composition 3-3 was changed to the outermost coating layer-coating composition 3-13.

<Outermost Coating Layer-Coating Composition 3-13>

The outermost coating layer-coating composition was prepared according to the following contents.

| | |
|---|---|
| Kaolin | 48 parts by mass |
| Ground calcium carbonate | 32 parts by mass |
| Synthetic amorphous silica | 20 parts by mass |
| Urea phosphate esterified starch | 15 parts by mass |
| Polyvinyl alcohol | 10 parts by mass |
| Calcium nitrate | 10 parts by mass |

The above contents were blended, mixed and dispersed with water, and the concentration of the composition was adjusted to 48% by mass.

### Example 3-14

A transfer paper of Example 3-14 was obtained in the same manner as in Example 3-3, except that the outermost coating layer-coating composition 3-3 was changed to the outermost coating layer-coating composition 3-14.

<Outermost Coating Layer-Coating Composition 3-14>

The outermost coating layer-coating composition was prepared according to the following contents.

| | |
|---|---|
| Kaolin | 42 parts by mass |
| Ground calcium carbonate | 28 parts by mass |
| Synthetic amorphous silica | 30 parts by mass |
| Urea phosphate esterified starch | 15 parts by mass |
| Polyvinyl alcohol | 10 parts by mass |
| Calcium nitrate | 10 parts by mass |

The above contents were blended, mixed and dispersed with water, and the concentration of the composition was adjusted to 48% by mass.

### Example 3-15

Coating layer-coating composition 3-1 was applied to a base paper on both sides with an air knife coater, dried, and then subjected to calendering processing to obtain a coated paper. The applied amount was 2 g/m² per side.

On this coated paper, the outermost coating layer-coating composition 3-3 was applied on both sides with a blade coater, dried and then subjected to calendering processing to obtain a transfer paper of Example 3-15. The applied amount was 6 g/m² per side.

<Coating Layer-Coating Composition 3-1>

The coating layer-coating composition was prepared according to the following contents.

| | |
|---|---|
| Ground calcium carbonate | 100 parts by mass |
| Styrene-butadiene copolymer | 15 parts by mass |
| Polyvinyl alcohol | 10 parts by mass |

The above contents were blended, mixed and dispersed with water, and the concentration of the composition was adjusted to 38% by mass.

### Example 3-16

A transfer paper of Example 3-16 was obtained in the same manner as in Example 3-3, except that the outermost coating layer-coating composition 3-3 was changed to the outermost coating layer-coating composition 3-15.

<Outermost coating layer-coating composition 3-15>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 3 parts by mass |
| Polyvinyl alcohol | 2 parts by mass |
| Calcium nitrate | 10 parts by mass |

The above contents were blended, mixed and dispersed with water, and the concentration of the composition was adjusted to 48% by mass.

### Example 3-17

A transfer paper of Example 3-17 was obtained in the same manner as in Example 3-3, except that the outermost coating layer-coating composition 3-3 was changed to the outermost coating layer-coating composition 3-16.

<Outermost Coating Layer-Coating Composition 3-16>

The outermost coating layer-coating composition was prepared according to the following contents.

| | |
|---|---|
| Kaolin | 60 parts by mass |
| Ground calcium carbonate | 40 parts by mass |
| urea phosphate esterified starch | 12 parts by mass |
| Polyvinyl alcohol | 8 parts by mass |
| Calcium nitrate | 10 parts by mass |

The above contents were blended, mixed and dispersed with water, and the concentration of the composition was adjusted to 48% by mass.

### Example 3-18

A transfer paper of Example 3-18 was obtained in the same manner as in Example 3-3, except that the outermost coating layer-coating composition 3-3 was changed to the outermost coating layer-coating composition 3-17.

<Outermost coating layer-coating composition 3-17>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 24 parts by mass |
| Polyvinyl alcohol | 16 parts by mass |
| Calcium nitrate | 10 parts by mass |

The above contents were blended, mixed and dispersed with water, and the concentration of the composition was adjusted to 48% by mass.

### Example 3-19

A transfer paper of Example 3-19 was obtained in the same manner as in Example 3-3, except that the outermost coating layer-coating composition 3-3 was changed to the outermost coating layer-coating composition 3-18.

<Outermost Coating Layer-Coating Composition 3-18>

The outermost coating layer-coating composition was prepared according to the following contents.

| | |
|---|---|
| Kaolin | 60 parts by mass |
| Ground calcium carbonate | 40 parts by mass |
| Urea phosphate esterified starch | 36 parts by mass |
| Polyvinyl alcohol | 24 parts by mass |
| Calcium nitrate | 10 parts by mass |

The above contents were blended, mixed and dispersed with water, and the concentration of the composition was adjusted to 48% by mass.

### Comparative Example 3-1

A transfer paper of Comparative Example 3-1 was obtained in the same manner as in Example 3-1, except that the outermost coating layer-coating composition 3-1 was changed to the outermost coating layer-coating composition 3-19.

<Outermost Coating Layer-Coating Composition 3-19>

The outermost coating layer-coating composition was prepared according to the following contents.

| | |
|---|---|
| Kaolin | 60 parts by mass |
| Ground calcium carbonate | 40 parts by mass |
| Oxidized starch | 15 parts by mass |
| Polyvinyl alcohol | 24 parts by mass |

The above contents were blended, mixed and dispersed with water, and the concentration of the composition was adjusted to 48% by mass.

### Comparative Example 3-2

A transfer paper of Comparative Example 3-2 was obtained in the same manner as in Example 3-1, except that the outermost coating layer-coating composition 3-1 was changed to the outermost coating layer-coating composition 3-20.

<Outermost Coating Layer-Coating Composition 3-20>

The outermost coating layer-coating composition was prepared according to the following contents.

| | |
|---|---|
| Kaolin | 60 parts by mass |
| Ground calcium carbonate | 40 parts by mass |
| Phosphate esterified starch | 15 parts by mass |
| Polyvinyl alcohol | 10 parts by mass |

The above contents were blended, mixed and dispersed with water, and the concentration of the composition was adjusted to 48% by mass.

### Comparative Example 3-3

A transfer paper of Comparative Example 3-3 was obtained in the same manner as in Example 3-1, except that the outermost coating layer-coating composition 3-1 was changed to the outermost coating layer-coating composition 3-21.

<Outermost Coating Layer-Coating Composition 3-21>

The outermost coating layer-coating composition was prepared according to the following contents.

| | |
|---|---|
| Kaolin | 100 parts by mass |
| Urea phosphate esterified starch | 15 parts by mass |
| Polyvinyl alcohol | 10 parts by mass |

The above contents were blended, mixed and dispersed with water, and the concentration of the composition was adjusted to 48% by mass.

### Comparative Example 3-4

A transfer paper of Comparative Example 3-4 was obtained in the same manner as in Example 3-1, except that the outermost coating layer-coating composition 3-1 was changed to the outermost coating layer-coating composition 3-22.

<Outermost Coating Layer-Coating Composition 3-22>

The outermost coating layer-coating composition was prepared according to the following contents.

| | |
|---|---|
| Ground calcium carbonate | 100 parts by mass |
| Urea phosphate esterified starch | 15 parts by mass |
| Polyvinyl alcohol | 10 parts by mass |

The above contents were blended, mixed and dispersed with water, and the concentration of the composition was adjusted to 48% by mass.

### Comparative Example 3-5

A transfer paper of Comparative Example 3-5 was obtained in the same manner as in Example 3-1, except that the outermost coating layer-coating composition 3-1 was changed to the outermost coating layer-coating composition 3-23.

<Outermost Coating Layer-Coating Composition 3-23>

The outermost coating layer-coating composition was prepared according to the following contents.

| | |
|---|---|
| Synthetic amorphous silica | 100 parts by mass |
| Urea phosphate esterified starch | 15 parts by mass |
| Polyvinyl alcohol | 10 parts by mass |

The above contents were blended, mixed and dispersed with water, and the concentration of the composition was adjusted to 48% by mass.

For coated paper type transfer paper, strike-through suppression property, image deterioration resistance and color development property were evaluated. The evaluation results are shown in Table 3.

TABLE 3

| | Strike-through | Image | Color |
|---|---|---|---|
| | suppression | deterioration | development |
| | property | resistance | property |
| Example 3-1 | B | B | A |
| Example 3-2 | A | B | A |
| Example 3-3 | A | A | A |
| Example 3-4 | A | A | A |
| Example 3-5 | A | B | A |
| Example 3-6 | A | B | A |
| Example 3-7 | A | A | A |
| Example 3-8 | B | A | A |
| Example 3-9 | A | A | A |
| Example 3-10 | A | B | A |
| Example 3-11 | B | A | A |
| Example 3-12 | A | B | A |
| Example 3-13 | A | A | A |
| Example 3-14 | B | A | A |
| Example 3-15 | A | A | A |
| Example 3-16 | A | A | B |
| Example 3-17 | A | A | A |
| Example 3-18 | A | A | A |
| Example 3-19 | B | A | A |
| Comparative | D | D | C |
| Example 3-1 | | | |
| Comparative | D | C | C |
| Example 3-2 | | | |
| Comparative | A | D | A |
| Example 3-3 | | | |
| Comparative | C | C | C |
| Example 3-4 | | | |
| Comparative | B | B | C |
| Example 3-5 | | | |

From the evaluation results in Table 3, it is understood that Examples 3-1 to 3-19 corresponding to the present invention are excellent in strike-through suppression property, and have good image deterioration resistance and color development property. However, it is understood that Comparative Examples 3-1 to 3-5 which do not satisfy the constitution of the present invention cannot obtain the effect of the present invention.

Mainly from the comparison between Example 3-1 and Example 3-2, it is understood that the outermost coating layer preferably contains a water-soluble calcium salt.

Also, mainly from the comparison of Example 3-3 and Example 3-9 with Example 3-10, it is understood that the water-soluble calcium salt is preferably at least one selected from the group consisting of calcium chloride and calcium nitrate.

1. A transfer paper, which is:
(i) a transfer paper without a coating layer, which comprises a pulp, a filler and an urea phosphate esterified starch, or
(ii) a transfer paper having a coating layer, which comprises a base paper and one or more coating layer(s) provided on at least one side of the base paper, wherein an outermost coating layer positioned on the outermost side with respect to the base paper contains at least kaolin, calcium carbonate and a binder, wherein,
(α) the base paper contains an urea phosphate esterified starch, or
(β) the outermost coating layer contains an urea phosphate esterified starch.

2. The transfer paper according to claim 1, which is (i) a transfer paper without a coating layer, which comprises a pulp, a filler and an urea phosphate esterified starch.

3. The transfer paper according to claim 2, wherein a content of the urea phosphate esterified starch in the transfer paper is 0.5 g/m² or more and 4 g/m² or less.

4. The transfer paper according to claim 2, wherein at least one of the filler is calcium carbonate.

5. The transfer paper according to claim 2, further comprising a polycondensate of an aliphatic monoamine or an aliphatic polyamine and an epihalohydrin compound.

6. The transfer paper according to claim 1, which is (ii) a transfer paper having a coating layer, which comprises a base paper and one or more coating layer(s) provided on at least one side of the base paper, wherein an outermost coating layer positioned on the outermost side with respect to the base paper contains at least kaolin, calcium carbonate and a binder, wherein,
(α) the base paper contains an urea phosphate esterified starch.

7. The transfer paper according to claim 6, wherein a content of the urea phosphate esterified starch in the base paper is 0.5 g/m² or more and 4 g/m² or less.

8. The transfer paper according to claim 6 or 7, wherein the base paper further contains a water-soluble calcium salt.

9. The transfer paper according to claim 1, which is (ii) a transfer paper having a coating layer, which comprises a base paper and one or more coating layer(s) provided on at least one side of the base paper, wherein an outermost coating layer positioned on the outermost side with respect to the base paper contains at least kaolin, calcium carbonate and a binder, wherein,
(β) the outermost coating layer contains an urea phosphate esterified starch.

10. The transfer paper according to claim 9, wherein a content of the urea phosphate esterified starch in the outermost coating layer is 2 parts by mass or more and 48 parts by mass or less with respect to 100 parts by mass of a pigment in the outermost coating layer.

11. The transfer paper according to claim 9, wherein the outermost coating layer further contains a water-soluble calcium salt.

12. The transfer paper according to claim 8, wherein the water-soluble calcium salt is at least one selected from the group consisting of calcium chloride and calcium nitrate.

13. The transfer paper according to claim 1, which is a transfer paper for printing a textile material.

14. A method for transfer printing of a textile material, which comprises using the transfer paper according to claim 1.

15. The transfer paper according to claim 4, further comprising a polycondensate of an aliphatic monoamine or an aliphatic polyamine and an epihalohydrin compound.

16. The transfer paper according to claim 11, wherein the water-soluble calcium salt is at least one selected from the group consisting of calcium chloride and calcium nitrate.
